(19) United States
(12) Patent Application Publication
(10) Pub. No.: US 2002/0073036 A1
(43) Pub. Date: Jun. 13, 2002

(54) Method and apparatus for holding a product in escrow "For Sale"

(76) Inventor: Brant Candelore, Escondido, CA (US)

Correspondence Address: Stephen T. Neal, Blakely, Sokoloff, Taylor & Zafman LLP, Seventh Floor, 12400 Wilshire Boulevard, Los Angeles, CA, 90025-1030, US

(21) Appl. No.: 09/972,526

(22) Filed: Oct. 5, 2001

Related U.S. Application Data
(60) Provisional application No. 60/254,310, filed on Dec. 8, 2000.

(51) Int. Cl. H04K 1/00; H04L 9/00; G06F 17/60

(52) U.S. Cl. 705/53

(57) ABSTRACT

A secure holder enables a buyer and seller to conduct a remote purchasing transaction while maintaining the security of the transaction. The secure holder controls a secure location. A seller places an item related to a remote purchasing transaction with the secure holder, who keeps the item in the secure location. The item can be an item for sale or an item related to a service for sale. The seller cannot access the item once the item is advertised for sale. A buyer wishing to purchase the item pays the secure holder or the seller, and the item is released to the buyer.

### BACKGROUND OF THE INVENTION

1. Provisional Application

This application claims priority under 35 U.S.C. §119(e) from provisional patent application U.S. Provisional Application No. 60/254,310 filed under 37 C.F.R. §1.53(d), entitled “Method and Apparatus for Holding a Product In Escrow ‘For Sale’ in E-Commerce Applications”, filed on Dec. 8,2000.

2. Field of the Invention

The present invention relates to a remote purchasing system and method. More specifically, it relates to a system and method for placing the object of a transaction in escrow while the transaction is being performed.

3. Art Background

Purchasing across remote distances comes with its own built-in set of problems. Rare luxury items can turn out to be fake, such as a forged Babe Ruth signed ball. Money gets sent but the merchandise is never delivered. The merchandise is delivered but the quality is bad. The item description is misleading. The merchandise is defective. The item pictured in the sale brochure or on the web site is different from the one that is shipped. The same item is sold to multiple buyers.

The seller is at risk as well. Even if they have received payment, for example via credit card, the buyer can improperly claim that the goods are defective and stop payment.

Problems with shipping also arise. Merchandise must be packaged and delivered to a shipper, as required by law if over one pound. The seller must wait until the post office is open, and then wait in-line to drop off and pay for shipping. Additionally, the seller typically needs to buy insurance in case the merchandise does not make it to its destination.

### SUMMARY

A secure holder enables a buyer and seller to conduct a remote purchasing transaction while maintaining the security of the transaction. The secure holder controls a secure location. A seller places an item related to a remote purchasing transaction with the secure holder, who keeps the item in the secure location. The item can be an item for sale or an item related to a service for sale. The seller cannot access the item once the item is advertised for sale. A buyer wishing to purchase the item pays the secure holder or the seller, and the item is released to the buyer.

### BRIEF DESCRIPTION OF THE DRAWINGS

The objects, features and advantages of the present invention will be apparent from the following detailed description in which:

FIG. 1a is a simplified block diagram of one embodiment of a commercial transaction using a secure holder.

FIG. 1b is a simplified flow diagram of one embodiment of a commercial transaction using the secure holder.

FIG. 2 is a simplified flow diagram of one embodiment of the relationship between a seller and the secure holder.

FIG. 3 is a simplified flow diagram of one embodiment of the relationship between a buyer and the secure holder.

FIG. 4 is a simplified diagram of a secure location used by the secure holder.

FIG. 5 is a simplified diagram of one embodiment of the interior of a secure location used by the secure holder.

FIG. 6 is a simplified block diagram of one embodiment of a secure transaction system.

FIG. 7 is a simplified block diagram of one embodiment of a privacy card for a personal transaction device.

FIG. 8 is a simplified block diagram of one embodiment of a digital wallet for a personal transaction device.

### DETAILED DESCRIPTION

In the following descriptions for the purposes of explanation, numerous details are set forth in order to provide a thorough understanding of the present invention. However, it will be apparent to one skilled in the art that these specific details are not required in order to practice the present invention. In other instances, well known electrical structures or circuits are shown in block diagram form in order not to obscure the present invention unnecessarily.

The buyer and the seller in a remote purchasing transaction, such as the sale of an item or an item related to a service for sale, can be given added protection by including in the transaction an escrow function. The escrow function secures an item related to a sales transaction with a secure holder prior to the item being offered for sale. In one embodiment, the secure holder performs the escrow function by storing an item related to the transaction in a secure location, such as a vault. In an alternate embodiment, the secure location is a temporary holding facility. The item may be the subject of the remote purchasing transaction or a peripheral item essential for the successful completion of the transaction. The secure holder, or a vault agent reporting to the secure holder, oversees the secure location, and guarantees that the item is not tampered with by the seller. In one embodiment, the vault agent is a computer program maintaining the secure location, the program overseen by the secure holder. The secure holder would have no interest in the current transaction.

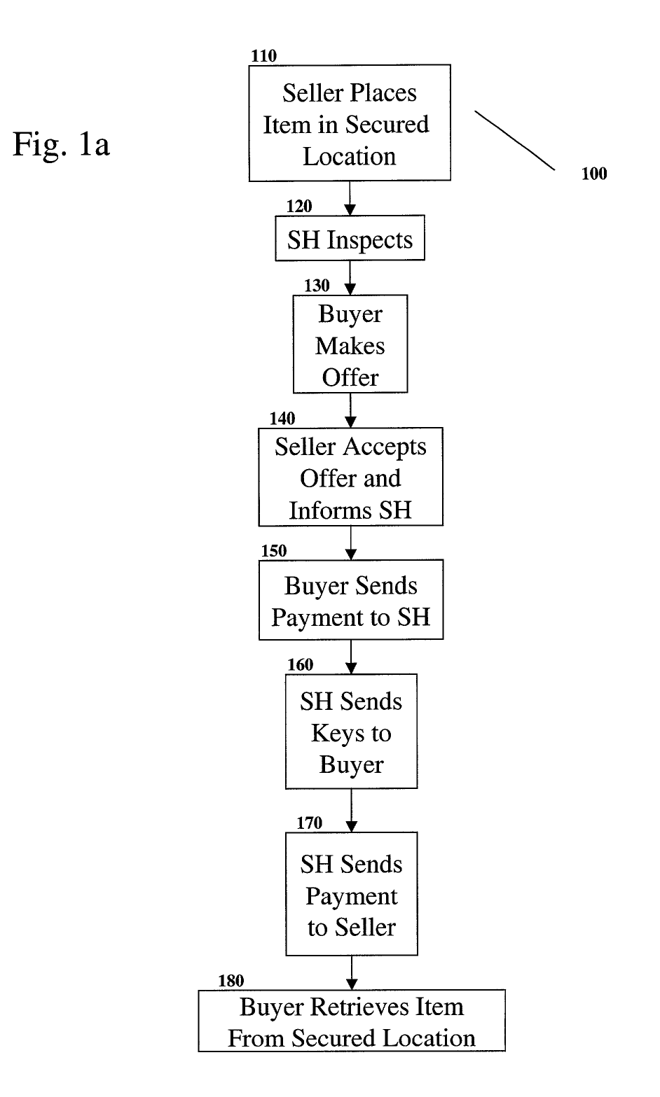

One embodiment of a secure holder 100 that uses the secure location is illustrated in the flow diagram of FIG. 1a and the block diagram of FIG. 1b. In block 110 and as shown by arrow A, the seller 115 places the item related to the remote purchasing transaction into the secure location 125. In block 120 and arrow B, the secure holder (SH) 135 may optionally inspect the item in the secure location 135. In one embodiment, the SH 135 maintains a database (SHDB) 145 of items in the secure location. In block 130 and arrow C, a prospective buyer 155 makes an offer to the seller 115. In block 140 and arrow D, the seller 115 accepts the offer and informs the SH 135 of his acceptance of the offer. In block 150 and arrow E, the buyer 155 sends payment to the SH 135. In block 160 and arrow F, upon receipt of the payment, the SH 135 sends a key, or some other technique of accessing the secure location, to the buyer 155. In block 170 and arrow G, the SH 135 sends the payment on to the seller 115. In block 180 and arrow H, the buyer 155 retrieves the item from the secure location 125. Block 180 and arrow H can happen anytime after the key to the secure location 125 is sent to the buyer 155.

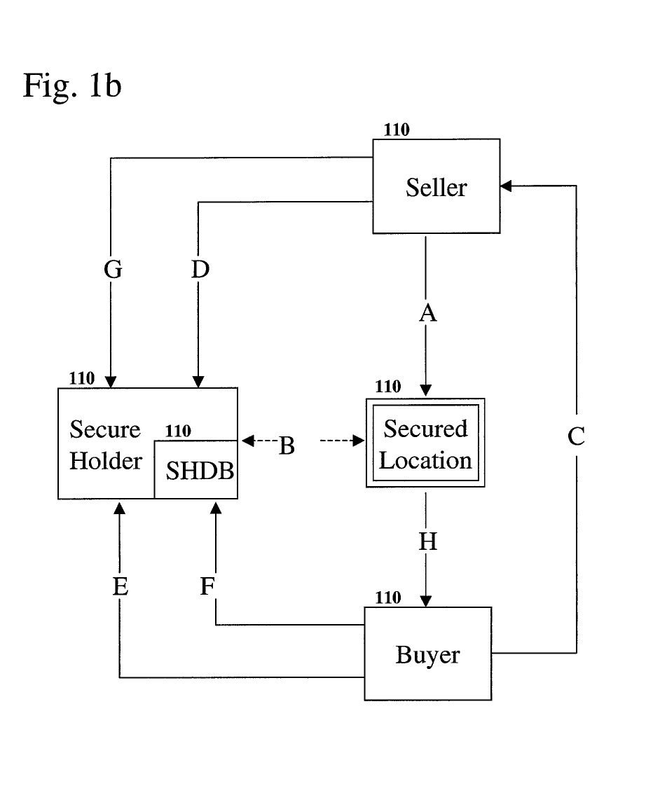

Verification methods can be added to the transactions between the seller and the secure holder and between the buyer and the secure holder. These verification methods would allow greater trust between the parties and increase the effectiveness of the secure holder. One embodiment of a verification method 200 between the secure holder 135 and the seller 115 is illustrated in FIG. 2. In block 210, the seller provides background information on the seller to the secure holder (SH). In one embodiment, this information includes a seller public certificate with a date and time and a seller private key. In block 220, the SH checks the background information of the seller to see if the seller is in good standing. In one embodiment this background check includes verifying that a public certificate for the seller has not been revoked, verifying that the date and time on the certificate are recent, and verifying that the date and time on the public key match the date and time on the seller public certificate. If the background check fails to satisfy the SH, in block 225 the SH does not store the item. In block 230, the SH provides the SH credentials to the seller. In one embodiment the SH credentials includes a secure holder public certificate with a date and time and an secure holder public key with an encrypted date and time. In block 240, the seller checks the secure holder credentials. If the credentials fail to satisfy the seller, in block 225 the seller does not store the item with the SH.

In block 250, the seller places the item related to the remote purchasing transaction into the secure location, or vault, and provides information about the sale to the SH. In one embodiment, this sales information includes the secure holder identification, the seller identification, the item description, signature of the seller, and the date and time of the seller signature. In a further embodiment, the sales information is encrypted with the secure holder public key. In one embodiment, the seller is prevented from accessing the item once the item has been placed on sale. In block 260, the SH provides receipt to the seller. In one embodiment, the receipt includes a seller identification, an item description, the signature of the seller, the date and time of the seller signature, the secure holder identification, asset identification, the signature of SH, and the date and time of the SH signature. In a further embodiment, the receipt is encrypted with the public key of the seller. In block 270, the seller decrypts the receipt.

In block 280, the SH or the seller advertises the product or service for sale, including the asset identification and the secure holder identification. In block 290, the buyer checks the SH database (SHDB) to see if the item or service is still available. In one embodiment, the buyer uses the asset identification and the secure holder identification to search the SHDB. In one embodiment, the status includes sold, pending, and still for sale. In a further embodiment, the buyer is presented with the time period by which the offer for sale will expire.

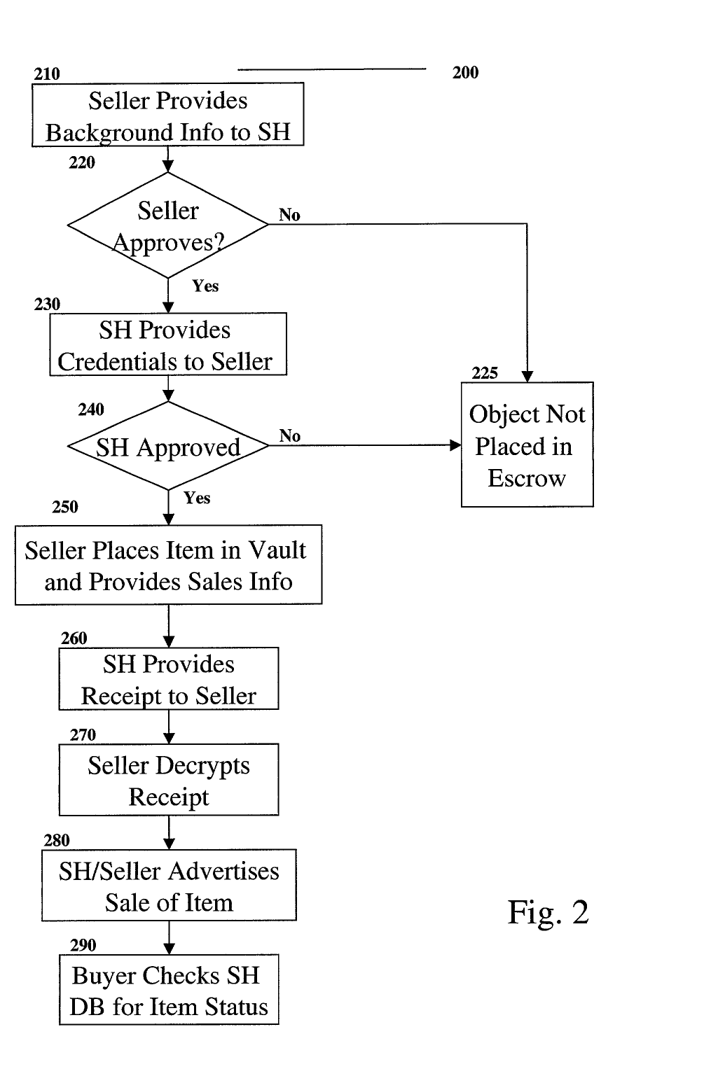

One embodiment of a verification method 300 between the secure holder and the buyer is illustrated in FIG. 3. In block 310, the buyer selects an item or service to buy. If the remote purchasing transaction is the sale of an item, the secure holder holds the item. If the remote purchasing transaction is the purchase of a service to be performed, the secure holder holds an item necessary for the performance of the service. In block 315, the buyer provides background information about the buyer to the SH. In one embodiment, the background information includes a buyer certificate. In decision block 320, the SH checks the buyer background information. If the buyer is approved, the SH checks the SH database for item availability in block 325. If the buyer is not approved, the buyer is informed that the offer is denied in block 330. In decision block 335, the SH decides whether to approve the purchase. If the purchase is denied, the buyer is informed of the denial in block 330. If the purchase is approved, the SH sends an electronic acceptance of the buyer's offer to the buyer in block 340. In one embodiment, the electronic acceptance includes asset identification, an item description, buyer identification, a signature of the SH, and the date and time of the SH signature.

In block 345, the buyer sends payment and provides sales information to the SH. In one embodiment, the sales information includes the asset identification, the price, the item description, the offer identification, the signature of the SH, the date and time of the SH signature, bank data for the buyer, the signature of the buyer, and the date and time of the buyer signature. The bank data is checked to ensure sufficient funds are present for the transaction. In block 350, the remote purchasing transaction is completed by accepting payment from the buyer and delivering payment to the seller.

In block 355, the confirmation and shipping information is sent to the buyer. In one embodiment, the shipping information includes the asset identification, the price, the item description, the buyer identification, the SH signature for the acceptance, the date and time of the SH signature for the acceptance, the bank data for the buyer, the buyer signature, the date and time for the buyer signature, confirmation, the shipping data, the SH signature for the confirmation, and the date and time of the SH signature for the confirmation. In block 360, the item is shipped. In an alternate embodiment, an electronic key or some other method of accessing the secure location is sent to the buyer. The electronic key is transmitted to the buyer's personal transaction device.

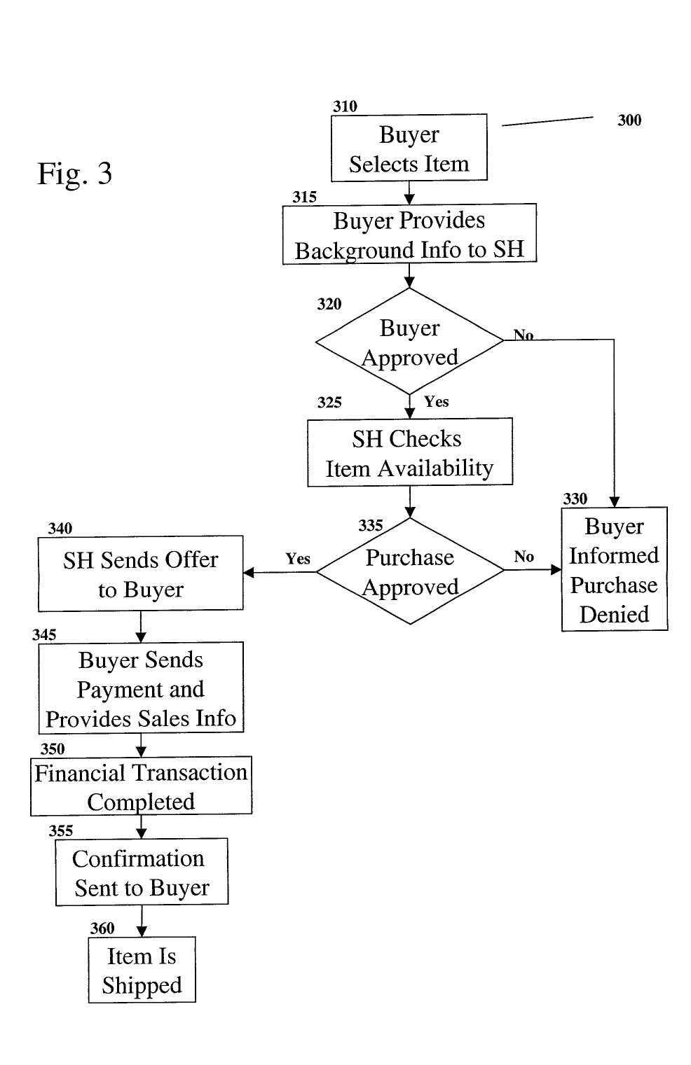

One embodiment of the interior of the secure location is illustrated in the diagram of FIG. 4. In one embodiment, the secure location 400 is divided into a plurality of separate compartments 410. The size and shape of the compartments can be varied as needed. In a further embodiment, an imaging device 420 is coupled to the interior of the secure location 400 to display the item contained within. This imaging device could be a video camera, a digital camera, or some other kind of image sensing device. A selection of imaging devices can be arranged to allow multiple views of the item. For instances where the item is a machine-readable medium containing the content to be sold, an interface 430 for reading the content is coupled to the interior. In one embodiment, a rotation device 440 is coupled to the floor of the secure location 400 to allow the item to be rotated and viewed from multiple angles by the imaging devices 420. In another embodiment, a remote manipulation device 450, such as a robotic arm, is coupled to the interior of the secure location 400 to allow the item to be manipulated by the buyer or the secure holder.

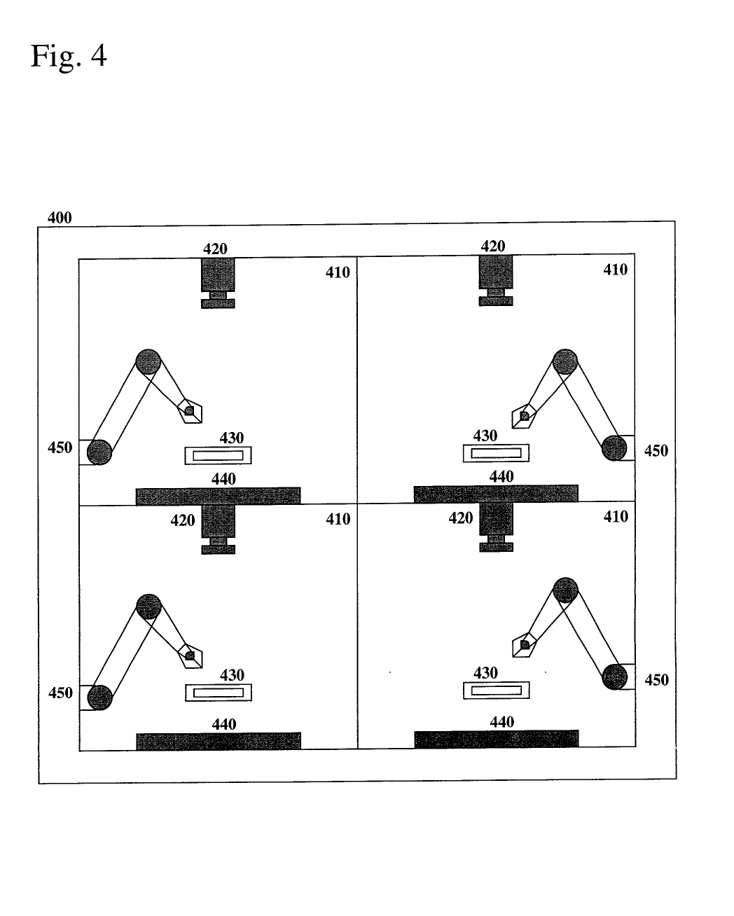

One embodiment of the secure location is illustrated in FIG. 5. A secure location 500, such as a vault, is appended to a satellite structure of the secure holder 510, such as a kiosk. The secure location 500 contains an item related to the transaction. A view screen 520, to allow the buyer to examine the interior of the secure location 500, is on the exterior of the secure location. In one embodiment, the view screen provides the buyer with options to perform on the item contained within. A user interface 530 allows the user to manipulate the item with in the secure location 500, to allow for a more extensive image on the view screen 520. A user interface can include a keypad, a number pad, a cursor control, or other input mechanisms. An interface 540 allows the user to access the secure location 500 using a key provided by the secure holder after successful completion of the transaction.

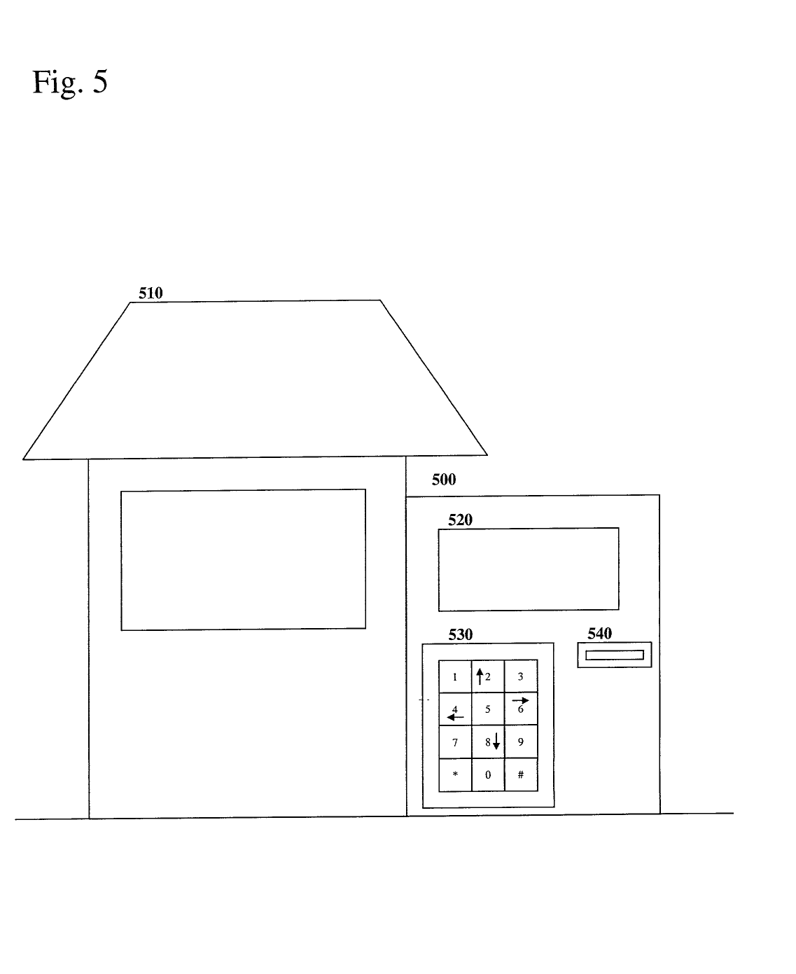

In one embodiment, the remote purchase transactions are performed electronically, and the secure holder and secure location work in conjunction with a secure transaction system. FIG. 6 is a block diagram of one embodiment of a secure transaction system. In this embodiment, a transaction privacy clearing house (TPCH) 615 interfaces a user (buyer) 640 and a seller (vendor) 625. In this particular embodiment, a personal transaction device (PTD) 670, e.g., a privacy card 605, or a privacy card 605 coupled to a digital wallet 650, is used to maintain the privacy of the user while enabling the user to perform transactions. In an alternate embodiment, the PTD 670 may be any suitable device that allows unrestricted access to TPCH 630. The personal transaction device information is provided to the TPCH 615 that then indicates to the seller 625 and the user 640 approval of the transaction to be performed.

In order to maintain confidentiality of the identity of the user 640, the transaction device information does not provide user identification information. Thus, the seller 625 or other entities do not have user information but rather transaction device information. The TPCH 615 maintains a secure database of transaction device information and user information. In one embodiment, the TPCH 615 interfaces to at least one remote commerce processing system 620 to perform associated remote purchasing transactions, such as confirming sufficient funds to perform the transaction, and transfers to the seller 625 the fees required to complete the transaction. In addition, the TPCH 615 may also provide information through a distribution system 630 that, in one embodiment, can provide a purchased product to the user 640, again without the seller 625 knowing the identification of the user 640. In an alternate embodiment, the remote commerce processing system 620 need not be a separate entity but may be incorporated with other functionality. For example, in one embodiment, the remote commerce processing system 620 may be combined with the TPCH 615 functionality.

In one embodiment, the remote commerce processing system (FP) 620 performs tasks of transferring funds between the user's account and the seller's account for each transaction. In one embodiment, the presence of the TPCH 615 means that no details of the transactions, other than the amount of the transactions and other basic information, are known to the FP 620. The TPCH 615 issues transaction authorizations to the FP 620function on an anonymous basis on behalf of the user over a highly secure channel. The FP 620does not need to have many electronic channels receiving requests for fund transfer, as in a traditional remote commerce processing system. In one embodiment, a highly secure channel is set up between the TPCH 615 and the FP 620; thus, the FP 620 is less vulnerable to spoofing.

In one embodiment, the FP 620 is contacted by the TPCH 615 requesting a generic credit approval of a particular account. Thus the FP 620 receives a minimal amount of information. In one embodiment, the transaction information, including the identification of goods being purchased with the credit need not be passed to the FP 620. The TPCH 615 can request the credit using a dummy charge ID that can be listed in the monthly credit statement sent to the user, so that the user can reconcile his credit statement. Further, the personal transaction device 605 can include functionality to cause the credit statement to convert the dummy charge ID back to the transactional information so that the credit statement appears to be a conventional statement that lists the goods that were purchased and the associated amount charged.

A display input device 660 (shown in phantom) may be included to enable the user, or in some embodiments the seller 625, to display status and provide input regarding the PTD 605 and the status of the transaction to be performed.

In yet another embodiment, an entry point 610 interfaces with the personal transaction device 670 and also communicates with the TPCH 615. The entry point 610 may be an existing (referred to herein as a legacy POS terminal) or a newly configured point of sale (POS) terminal located in a retail environment. The user 640 uses the PTD 670 to interface to the POS terminal in a manner similar to how credit cards and debit cards interface with POS terminals. The entry point 610 may also be a public kiosk, a personal computer, or the like.

The system described herein also provides a distribution functionality 630 whereby products purchased via the system are distributed. In one embodiment, the distribution function 630 is integrated with the TPCH 615 functionality. In an alternate embodiment, the distribution function 630 may be handled by a third party. Utilizing either approach, the system ensures user privacy and data security. The distribution function 630 interacts with the user through PTD 630 to ship the product to the appropriate location. A variety of distribution systems are contemplated, for example, electronic distribution through a POS terminal coupled to the network, electronic distribution direct to one or more privacy cards and/or digital wallets, or physical product distribution. In one embodiment for physical product distribution, an “anonymous drop-off point”, such as a convenience store or other ubiquitous location is used. In another embodiment, it involves the use of a “package distribution kiosk” that allows the user to retrieve the package from the kiosk in a secure fashion. However, in one embodiment, the user may use PTD 670 to change the shipping address of the product at any time during the distribution cycle. In one embodiment, the secure holder is a person associated with the TPCH.

A user connects to and performs transactions with a secure transaction system (such as shown in FIG. 6) through a personal transaction device (PTD) that has a unique identifier (ID). In one embodiment, a privacy card is used. In an alternate embodiment a digital wallet is used. In yet another alternate embodiment, a privacy card in conjunction with a digital wallet is used.

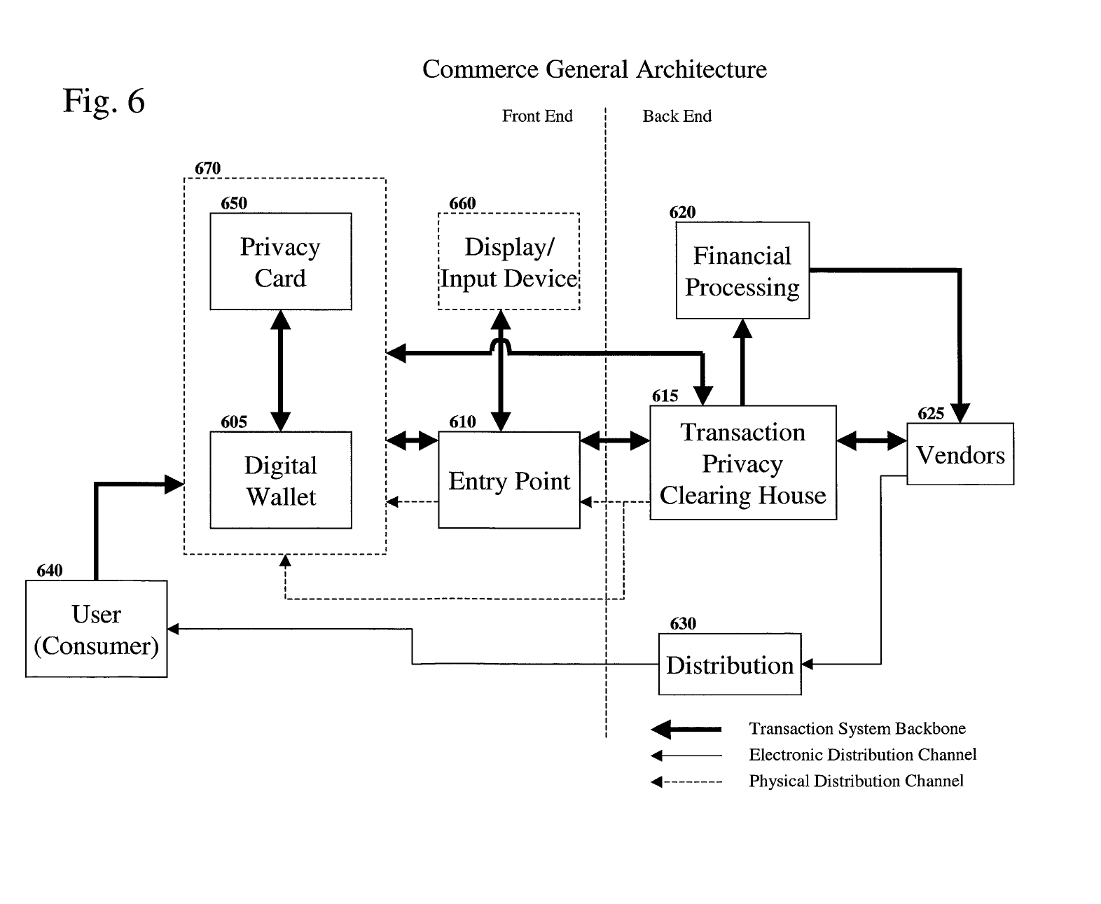

One embodiment of a privacy card 705 is illustrated in FIG. 7. In one embodiment, the card 705 is configured to be the size of a credit card. The privacy card includes a processor 710, memory 715 and input/output logic 720. The processor 710 is configured to execute instructions to perform the functionality herein. The instructions may be stored in the memory 715. The memory is also configured to store data, such as transaction data and the like. In one embodiment, the memory 715 stores the transaction ID used to perform transactions in accordance with the teachings of the present invention. Alternately, the processor may be replaced with specially configured logic to perform the functions described here.

The input/output logic 720 is configured to enable the privacy card 705 to send and receive information. In one embodiment, the input/output logic 720 is configured to communicate through a wired or contact connection. In another embodiment, the logic 720 is configured to communicate through a wireless or contactless connection. A variety of communication technologies may be used.

In one embodiment, a display 725 is used to generate bar codes scanable by coupled devices and used to perform processes as described herein. The privacy card 705 may also include a magnetic stripe generator 740 to simulate a magnetic stripe readable by devices such as legacy POS terminals.

In one embodiment, biometric information, such as fingerprint recognition, is used as a security mechanism that limits access to the card 705 to authorized users. A fingerprint touch pad and associated logic 730 is therefore included in one embodiment to perform these functions. Alternately, security may be achieved using a smart card chip interface 750, which uses known smart card technology to perform the function.

Memory 715 can have transaction history storage area. The transaction history storage area stores transaction records (electronic receipts) that are received from POS terminals. The ways for the data to be input to the card include wireless communications and the smart card chip interface which functions similar to existing smart card interfaces. Both of these approaches presume that the POS terminal is equipped with the corresponding interface and can therefore transmit the data to the card.

Memory 715 can also have user identity/account information block. The user identity/account information block stores data about the user and accounts that are accessed by the card. The type of data stored includes the meta account information used to identify the account to be used.

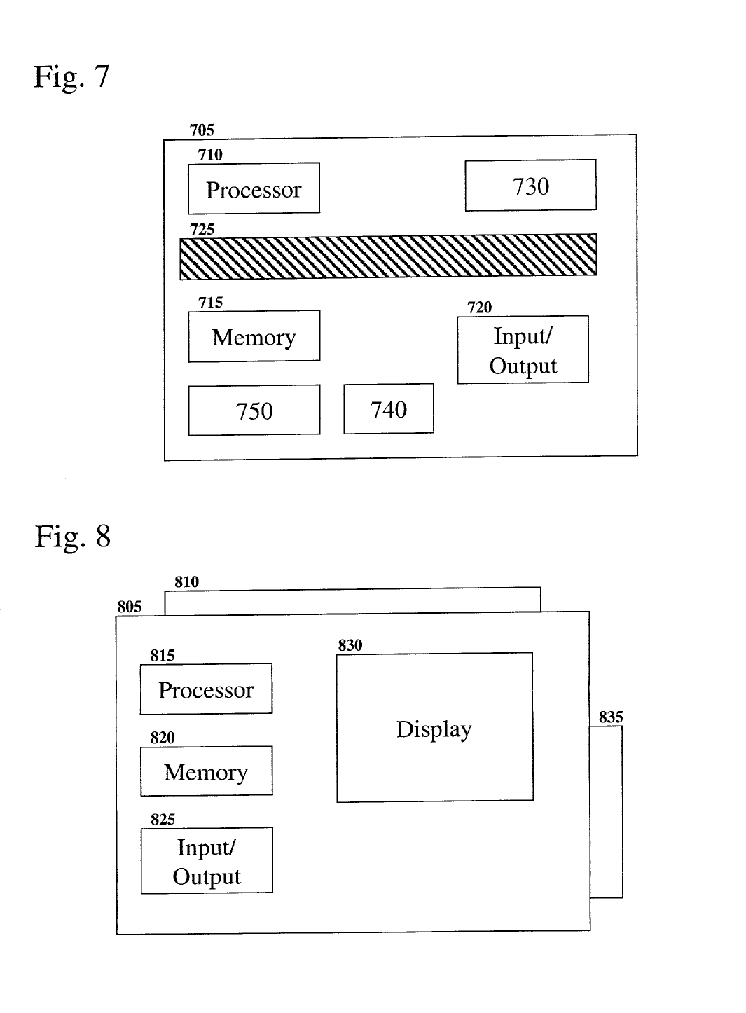

One embodiment of a digital wallet 805 is illustrated in FIG. 8. The digital wallet 805 includes a coupling input 810 for the privacy card 705, processor 815, memory 820, input/output logic 825, display 830 and peripheral port 835. The processor 815 is configured to execute instructions, such as those stored in memory 820, to perform the functionality described herein. Memory 820 may also store data including financial information, electronic coupons, shopping lists and the like. The digital wallet may be configured to have additional storage. In one embodiment, the additional storage is in a form of a card that couples to the device through peripheral port 810.

In one embodiment, the privacy card 705 couples to the digital wallet 805 through port 810; however, the privacy card 705 may also couple to the digital wallet 805 through another form of connection including a wireless connection.

Input/output logic 825 provides the mechanism for the digital wallet 805 to communicate information. In one embodiment, the input/output logic 825 provides data to a point-of-sale terminal or to the privacy card 705 in a pre-specified format. The data may be output through a wired or wireless connection.

The digital wallet 805 may also include a display 830 for display of status information to the user. The display 830 may also provide requests for input and may be a touch sensitive display, enabling the user to provide the input through the display.

The physical manifestation of many of the technologies in the digital wallet 805 will likely be different from those in the privacy card 705, mainly because of the availability of physical real estate in which to package technology. Examples of different physical representations would include the display, fingerprint recognition unit, etc.

The invention has been described in conjunction with the preferred embodiment. It is evident that numerous alternatives, modifications, variations and uses will be apparent to those skilled in the art in light of the foregoing description. The components of a secure transaction system illustrated in FIGS. 6, 7, and 8 are further described in PCT published patent application number US00/35619, which is assigned to the same assignee as the present application and which is hereby incorporated by reference.

What is claimed is:

1. A method comprising:
securing an item at a secure location by a secure holder, said secure holder being a third party separate from a seller and a buyer;
offering the item for sale after the item has been secured by the secure holder; and
upon completion of as purchased of the secured item, providing the buyer authorization for access to the item.

2. The method of claim 1, wherein accepting the item further comprises:
denying the seller of the item access to the item once the item is accepted by the holder.

3. The method of claim 1, wherein accepting the item further comprises:
verifying background information of the seller of the item.

4. The method of claim 1, wherein accepting the item further comprises:
providing background information of the secure holder to the seller of the item.

5. The method of claim 1, wherein accepting the item further comprises:
marketing the item through a remote purchasing system.

6. The method of claim 1, wherein accepting the item further comprises:
marketing the item at a public location.

7. The method of claim 1, wherein accepting the item further comprises:
viewing the item from a remote site via an imaging remotely coupled to the secure location.

8. The method of claim 1, wherein accepting the item further comprises:
manipulating the item from a remote site via a remote manipulation device.

9. The method of claim 1, wherein accepting the item further comprises:
viewing the item at a public location via an imaging device coupled to an interior section of the location.

10. The method of claim 1, wherein accepting the item further comprises:
manipulating the item at a public location through a remote manipulation device coupled to an interior section of the secure location.

11. The method of claim 1, wherein accepting the item further comprises:
conducting a remote purchasing transaction between the buyer and the seller, the buyer and the seller being physically removed from each other during the remote purchasing transaction.

12. The method of claim 1, wherein accepting the item further comprises:
allowing access through use of a transaction device.

13. The method of claim 12, wherein accepting the item further comprises:
maintaining an association in a secure server between the buyer and the transaction device using a transaction device identifier.

14. The method of claim 12, wherein the transaction device is selected from the group consisting of a privacy card, digital wallet, and a privacy card configured to be coupled to a digital wallet.

15. A remote purchasing transaction system comprising:
a secure holder to secure an item to be offered for sale at a future date and to provide a buyer with authorization for access to the item upon completion of a purchased of the secured item, the secure holder a third party separate from a seller and the buyer.

16. The remote purchasing transaction system of claim 15, further comprising a transaction privacy clearinghouse (TPCH) coupled to the secure holder, the TPCH to interact with a transaction device identifier and to authorize the transaction based upon the transaction device identifier and account information of the buyer without providing the identity of the buyer.

17. The remote purchasing transaction system of claim 15, wherein the secure holder denies the seller of the item access to the item once the item is accepted by the holder.

18. The remote purchasing transaction system of claim 15, wherein the secure holder verifies background information of the seller of the item.

19. The remote purchasing transaction system of claim 15, wherein the secure holder provides background information of the secure holder to a seller of the item.

20. The remote purchasing transaction system of claim 15, wherein the secure holder markets the item through a remote purchasing system.

21. The remote purchasing transaction system of claim 15, wherein the secure holder markets the item at a public location.

22. The remote purchasing transaction system of claim 15, further comprising an imaging remotely coupled to the secure location for the buyer to view the item from a remote site.

23. The remote purchasing transaction system of claim 15, further comprising a remote manipulation device for the buyer to manipulate the item from a remote site.

24. The remote purchasing transaction system of claim 15, further comprising an imaging device coupled to an interior section of the location for the buyer to view the item at a public location.

25. The remote purchasing transaction system of claim 15, further comprising a remote manipulation device coupled to an interior section of the secure location for the buyer to manipulate the item at a public location.

26. The remote purchasing transaction system of claim 15, wherein the secure holder conducts a remote purchasing transaction between the buyer and the seller, the buyer and the seller being physically removed from each other during the remote purchasing transaction.

27. The remote purchasing transaction system of claim 15, wherein the secure holder allows access through use of a transaction device.

28. The remote purchasing transaction system of claim 27, wherein the secure holder maintains an association in a secure server between a buyer and the transaction device using a transaction device identifier.

29. The remote purchasing transaction system of claim 27, wherein the transaction device is selected from the group consisting of a privacy card, digital wallet, and a privacy card configured to be coupled to a digital wallet.

30. A machine-readable storage medium having a sequence of instructions executable to cause a machine to perform a method comprising:
securing an item at a secure location by a secure holder, said secure holder being a third party separate from a seller and a buyer;
offering the item for sale after the item has been secured by the secure holder; and
upon completion of as purchased of the secured item, providing the buyer authorization for access to the item.

31. The machine-readable storage medium of claim 30, wherein accepting the item further comprises:
denying a seller of the item access to the item once the item is accepted by the holder.

32. The machine-readable storage medium of claim 30, wherein accepting the item further comprises:
verifying background information of a seller of the item.

33. The machine-readable storage medium of claim 30, wherein accepting the item further comprises:
providing background information of the secure holder to a seller of the item.

34. The machine-readable storage medium of claim 30, wherein accepting the item further comprises:
marketing the item through a remote purchasing system.

35. The machine-readable storage medium of claim 30, wherein accepting the item further comprises:
marketing the item at a public location.

36. The machine-readable storage medium of claim 30, wherein accepting the item further comprises:
viewing the item from a remote site via an imaging remotely coupled to the secure location.

37. The machine-readable storage medium of claim 30, wherein accepting the item further comprises:
manipulating the item from a remote site via a remote manipulation device.

38. The machine-readable storage medium of claim 30, wherein accepting the item further comprises:
viewing the item at a public location via an imaging device coupled to an interior section of the location.

39. The machine-readable storage medium of claim 30, wherein accepting the item further comprises:
manipulating the item at a public location through a remote manipulation device coupled to an interior section of the secure location.

40. The machine-readable storage medium of claim 30, wherein accepting the item further comprises:
conducting a remote purchasing transaction between a buyer and a seller, the buyer and the seller being physically removed from each other during the remote purchasing transaction.

41. The machine-readable storage medium of claim 30, wherein accepting the item further comprises:
allowing access through use of a transaction device.

42. The machine-readable storage medium of claim 41, wherein accepting the item further comprises:
maintaining an association in a secure server between a buyer and the transaction device using a transaction device identifier.

43. The machine-readable storage medium of claim 41, wherein the transaction device is selected from the group consisting of a privacy card, digital wallet, and a privacy card configured to be coupled to a digital wallet.
